(19) United States
(12) Patent Application Publication
(10) Pub. No.: US 2011/0274791 A1
(43) Pub. Date: Nov. 10, 2011

(54) MULTIVITAMIN/MINERAL FORMULATION TO COMBAT THE EFFECTS OF ENVIRONMENTAL STRESS; IMPROVED IMMUNITY AND IMPROVE ENERGY WHILE ADDRESSING VITAMIN AND MINERAL DEFICIENCIES WITHOUT THE NEGATIVE SIDE EFFECTS OF A MEGA DOSE NUTRITIONAL SUPPLEMENT

(75) Inventors: Richard Cotter, Mendham, NJ (US); Charles Mohs, Morristown, NJ (US); Lisa Dispensa, Airmont, NY (US); Paula Ziegler, Madison, NY (US)

(73) Assignee: WYETH LLC

(21) Appl. No.: 13/145,806

(22) PCT Filed: Jan. 21, 2010
(86) PCT No.: PCT/US10/21595

§ 371 Date: Jul. 22, 2011

Related U.S. Application Data
(60) Provisional application No. 61/146,689, filed on Jan. 23, 2009.

(51) Int. Cl. A23L 1/302; A23L 1/304; A23L 1/303

(52) U.S. Cl. 426/73; 426/72

(57) ABSTRACT

A nutritional supplement, and methods of use thereof, are provided that are designed to be most effective in optimizing health, improving energy and appearance, reducing the effects of environmental stress and improving, aiding, assisting a person's immunity, including but not limited to decreasing the instances, duration and severity of cold infections.

### BACKGROUND OF THE INVENTION

Nutritional deficiencies occurring in adults are many and vary according to geographic setting and socioeconomic status of the individual. Even though such deficiencies are less common among adults 20-50 compared to the elderly, these deficiencies do occur even in industrialized countries such as the United States. Poverty as well as lack of nutrition knowledge and health education among individuals compounds the problem. Factors other than poverty can also lead to nutrient deficiencies in adults ages 20 to 50. Many adults lead very busy lives and do not eat a balanced diet. This life style often leads to missed meals, especially breakfast, and unbalanced lunches. Although some foods sold in the market are fortified with a few nutrients, this is not a systematic fortification leaving grounds for deficiencies. Furthermore, common illnesses and infections to adults, such as respiratory infections and physiological states such as menstruation in females worsen the risk of nutritional deficiencies.

Although adult nutritional supplements are available commercially, the amounts of nutrients contained in the supplements are generally arbitrary and lack a scientific or experimental basis. Vitamin and mineral preparations are commonly administered as general nutritional supplements, focused upon “completeness” providing one of each vitamin and/or mineral and are not specifically formulated to address specific dietary and nutritional needs based upon individual lifestyles.

A high percentage of men and women over 20 years of age do not meet the dietary requirements of vitamins and/or minerals. According to the NHANES 1999-2000 study, over 23% of women over 20 years of age do not meet the dietary requirements of niacin and over 25% of women over 20 years of age do not meet the dietary requirements of iron. Overall, there is a very high prevalence of sub-optimal vitamin levels in diets (Flood et al., J. Natl. Cancer Inst. 2000; 92:1706). While poor dietary intake of vitamins remains the primary reason for this prevalence, many vitamins can be depleted due to other factors such as alterations in hormone levels, menopause, aging, alcohol consumption, smoking, genetics, environmental factors, and consumption of certain prescription medications. A recent article in JAMA concluded, “it appears to be prudent for all adults to take vitamin supplementation” (Fletcher et al., JAMA 2002, 287(23):3127). Therefore, there is a need for daily vitamin and mineral supplementation.

Micronutrients are elements or compounds which are present in foods in small or trace amounts and includes vitamins, minerals, or other elements and compounds found in foods for which many have not yet qualified for a recommended daily allowance (RDA). The macronutrients consist of carbohydrates, fats, and proteins that supply nutrients and calories and mostly are consumed via food and dietary intake. Some micronutrients such as calcium, sodium, potassium, chloride, and phosphorus are consumed in relatively large amounts, while many others such as iron, iodine, and zinc are consumed in small amounts. Vitamins, such as B12 and folic acid, and minerals such as selenium, are consumed in very small or trace amounts. In as much as the human body does not synthesize many compounds which are essential to the human body, these specific vitamins and minerals can be obtained from only two sources: food and supplements.

The primary source of all nutrients is food. However, the majority of people do not meet the RDA of essential micronutrients through food consumption. Thus, vitamin and mineral supplementation has become a recognized method of meeting accepted medical and health standards.

In an effort to combat these sub-optimal vitamin levels, there have been a variety of nutritional supplements made available to the public. Very typically, these vitamin and mineral supplement formulations are developed so that each dietary ingredient is at one hundred percent of the RDA without any focus upon key ingredients or supplementation to deliver specific consumer benefits.

In the alternative, some people and vitamin products take nutritional supplementation to the extreme through megadose vitamin therapy. Megadose vitamin therapy is the use of vitamins in amounts considerably greater than the RDA, often at excessive levels of 200%, 300% etc. However, megadoses of vitamins and/or minerals can have harmful effects. It is appreciated by those skilled in the art that administration of very large doses of certain vitamins, for example vitamins A, C, D and B6 can lead to vitamin toxicity and other serious health consequences. Vitamin toxicity is a condition in which a person develops symptoms as side effects from taking massive doses of vitamins. Vitamin toxicity, which is also called hypervitaminosis or vitamin poisoning, is becoming more common in developed countries because of the popularity of vitamin supplements. Vitamins vary in the amounts that are required to cause toxicity and in the specific symptoms that result.

Therefore, the inventors wanted to provide formulations that are specifically formulated to combat the effects of environmental stress, improve immunity and improve energy, while addressing vitamin and nutrient deficiencies without the negative side effects of a megadose nutritional supplement. The compositions of the present invention are balanced formulas that address specific indications without using megadose vitamin therapy.

Therefore, there exists a need for a nutritional supplement that supplies the right amount of the right micronutrients to assure adequate intake needed for disease prevention and protection against nutritional losses and deficiencies due to lifestyle factors and common inadequate dietary patterns.

### SUMMARY OF THE INVENTION

In accordance with the present invention, there is provided a nutritional supplement for consumers 18 to 50 years of age that supplies the right amount of the right micronutrients to assure adequate intake of micronutrients needed for disease prevention and protection against nutritional losses and deficiencies due to lifestyle factors and common inadequate dietary patterns.

In one embodiment of the invention provides for methods and nutritional supplements for improving energy in a human subject in need thereof comprising (1) an effective amount of vitamin B1, an effective amount of vitamin B2, an effective amount of niacin, an effective amount of vitamin B6, an effective amount of biotin, and an effective amount of pantothenic acid; and (2) wherein the weight ratio of biotin to vitamin B1 is between 1:20 to 1:25; wherein the weight ratio of biotin to vitamin B2 is between 1:25 to 1:30; wherein the weight ratio of biotin to niacin is between 1:310 to 1:330; wherein the weight ratio of biotin to vitamin B6 is between 1:30 to 1:35; wherein the weight ratio of biotin to pantothenic acid is between 1:110 to 1:130; and (b) wherein the human subject has improved energy.

In another embodiment of the invention provides for methods and nutritional supplements for reducing the effects of environmental stress and improving immunity in a human subject comprising (a) an effective amount vitamin E, vitamin C, and selenium; and (b) wherein the percent weight ratio of selenium to vitamin E is about 1:450 to about 1:550, the ratio of selenium to vitamin C is about 1:3000 to about 1:3500, and (c) wherein the nutritional supplement is adapted for reducing the effects of environmental stress and improving immunity.

In another embodiment of the invention is provided a nutritional supplement for improving energy in a human subject comprising (a) about 125% to about 130% of the recommended daily allowance of vitamin B1; (b) about 120 to about 130% of the recommended daily allowance of vitamin B2; (c) about 120 to about 130% of the recommended daily allowance of niacin; (d) about 130 to about 150% of the recommended daily allowance of vitamin B6; (e) about 120 to about 130% of the recommended daily allowance of biotin; (f) about 120 to about 130% of the recommended daily allowance of pantothenic acid and (e) wherein the nutritional supplement is adapted to improve the energy of the human subject.

In another embodiment of the invention is provided a nutritional supplement for reducing the effects of environmental stress and improving immunity in a human subject comprising (a) about 120 to about 130% of the recommended daily allowance of vitamin E, (b) about 120 to about 130% of the recommended daily allowance of vitamin C, (c) about 20 to about 40 mcg of selenium; and (d) wherein the nutritional supplement is adapted for reducing the effects of environmental stress and improving immunity in a human subject.

In yet another embodiment of the invention is provided methods for reducing the effects of environmental stress and improving immunity and reducing the duration of a cold infection in a human subject comprising administering a nutritional supplement comprising (a) an effective amount vitamin E, vitamin C, and selenium; and (b) wherein the ratio of selenium to vitamin E is about 1:500, the ratio of selenium to vitamin C is about 1:3333; and (c) wherein duration and frequency of the cold infection is reduced.

In still yet another embodiment of the invention is provided a nutritional supplement that reduces the effects of environmental stress and improves immunity and reduces the duration and frequency of a cold comprising (a) an effective amount vitamin E, vitamin C, and selenium; and (b) wherein the percent weight ratio of selenium to vitamin E is about 1:500, the percent weight ratio of selenium to vitamin C is about 1:3333.

In still yet another embodiment is provided a method for improving energy in a human subject in need thereof comprising (a) administering a nutritional supplement comprising (1) an effective amount of vitamin B1, an effective amount of vitamin B2, an effective amount of niacin, an effective amount of vitamin B6, an effective amount of biotin, and an effective amount of pantothenic acid; and (2) wherein the weight ratio of biotin to vitamin B1 is about 1:22; wherein the weight ratio of biotin to vitamin B2 is about 1:28; wherein the weight ratio of biotin to niacin is about 1:320; wherein the weight ratio of biotin to vitamin B6 is about 1:32; wherein the weight ratio of biotin to pantothenic acid is about 1:120; and (b) wherein the human subject has improved energy.

In yet a further embodiment of the invention is provided a nutritional supplement for reducing the effects of environmental stress and improving energy and immunity in a human subject in need thereof comprising (a) an effective amount of vitamin B1, an effective amount of vitamin B2, and effect amount of niacin, an effective amount of vitamin B6, an effective amount of pantothenic acid, an effective amount of vitamin E, an effective amount of vitamin C and an effective amount of selenium, and (b) wherein the weight ratio of biotin to vitamin B1 is between 1:20 to 1:25; wherein the weight ratio of biotin to vitamin B2 is between 1:20 to 1:25; wherein the weight ratio of biotin to niacin is between 1:310 to 1:330; wherein the weight ratio of biotin to vitamin B6 is between 1:30 to 1:35; wherein the weight ratio of biotin to pantothenic acid is between 1:110 to 1:130; wherein the weight ratio of selenium to vitamin E is between 1:450 to 1:550; wherein the weight ratio of selenium to vitamin C is between 1:3000 to 1:3500; and (c) wherein the nutritional supplement is adapted for reducing the effects of environmental stress and improving energy and immunity.

### DETAILED DESCRIPTION OF THE INVENTION

The age adjusted, targeted nutritional supplements of the present invention are particularly useful for human subjects older than eighteen (18) years of age, to not only complement daily food intake, but to support specific health benefits to nutritionally supplement the daily diet as well as to ensure vitality, health and well being. The compositions and methods described herein are intended for administration to adults between the ages of 18 and 50 years old. There is presently no commercially available nutritional supplement that may improve energy, improve immunity, and/or protect against environmental stress without the use of megadose vitamin therapy. The nutritional supplements of the present invention are designed to replenish vitamins and minerals that the body loses on a daily basis and to provide the body with a full range of nutrients that it needs for optimal functionality to fight fatigue and tiredness and contribute to the consumers overall well being.

The nutritional supplements of the present invention have been uniquely formulated to address specific nutritional needs of human subjects. More specifically, the inventors believe that specific nutritional compositions in tailored ratios and amounts may be used to reduce the effects of environmental stress upon the human body and thereby strengthen the immune system and/or improve energy in the consumer who is between the ages of 18 and 50 years old. The inventors believe that with the methods and nutritional supplements described herein, they may achieve these endpoints/effects without the use of megadose vitamin therapy, which historically has been the preferred method of achieving such effects.

In one embodiment, the nutritional supplement of the present invention may be used to improve or enhance the energy of a human subject. As used herein, “improved energy” and “enhanced energy” includes improved physical strength, improved vitality, reduced tiredness and sleepiness, improved transport of oxygen for energy production; enhanced physical endurance and stamina. It is believed that the compositions of the invention may unlock energy in the human body to maintain the health and vitality of the consumer and therefore result in improving and/or enhancing the energy of the consumer. The energy improving and/or enhancing nutritional supplement of the present invention can be used as nutritional support during periods of physical stress such as exercise.

The energy improving nutritional supplements of the present invention comprise an effective amount of vitamin B1, an effective amount of vitamin B2, an effective amount of niacin, an effective amount of vitamin B6, an effective amount of biotin, and an effective amount of pantothenic acid; and wherein the weight ratio of biotin to vitamin B1 is between 1:20 to 1:25; wherein the weight ratio of biotin to vitamin B2 is between 1:25 to about 1:30; wherein the weight ratio of biotin to niacin is between 1:310 to 1:330; wherein the weight ratio of biotin to vitamin B6 is between 1:30 to about 1:35; wherein the weight ratio of biotin to pantothenic acid is between 1:110 to 1:130; and wherein the human subject has improved and/or enhanced energy. In a further embodiment, the weight ratio of biotin to vitamin B1 is about 1:22; the weight ratio of biotin to vitamin B2 is about 1:28; the weight ratio of biotin to niacin is about 1:320; the weight ratio of biotin to vitamin B6 is about 1:32; and the weight ratio of biotin to pantothenic acid is about 1:120.

Vitamin B1, also referred to as thiamine, is a water-soluble substance with thiazole and pyrimadine rings joined by a methylene bridge and has a biological half-life in the body of about 15 days. Thiamin is essential for neural function and carbohydrate metabolism and is dosed in the form of a pharmaceutically acceptable vitamin B1 compound. As used herein, “pharmaceutically acceptable” is a component suitable for use in humans without undue side effects, such as irritation, toxicity, and allergic response. Useful pharmaceutically acceptable vitamin B1 compounds include, but are not limited to thiamine chloride hydrochloride and thiamine mononitrate. In a preferred embodiment, the effective amount of vitamin B1 is from about 0.5 to about 2 mg/per day. In an even more preferred embodiment, the effective amount of B1 is about 1.4 mg/day.

Vitamin B2, also referred to as riboflavin, participates in oxidation-reduction reactions in numerous metabolic pathways and in energy production via the respiratory chain. In one embodiment, the effective amount of Vitamin B2 is from about 1 to about 2 mg per day; most preferably in about 1.75 mg per day.

Niacin is required for cell respiration, helps in the release of energy and metabolism of carbohydrates, fats, and proteins, proper circulation and healthy skin, functioning of the nervous system, and normal secretion of bile and stomach fluids. It is used in the synthesis of sex hormones, treating schizophrenia and other mental illnesses, and a memory-enhancer. Niacin given in pharmaceutical dosage improves the blood cholesterol profile, and has been used to clear the body of organic poisons, such as certain insecticides. In one embodiment, the effective amount of niacin is from about 15 to about 30 mg per day, most preferably 20 mg per day.

Vitamin B6 or pyridoxine is involved in the production of RNA and DNA and many other biological reactions in the human body. Pyridoxal phosphate, the metabolically active form of vitamin B6, is involved in many aspects of macronutrient metabolism, neurotransmitter synthesis, histamine synthesis, hemoglobin synthesis and function and gene expression. Useful pharmaceutically acceptable vitamin B6 compounds include, but are not limited to pyridoxine, pydroxal and pyridoxamine, or salts thereof, including but not limited to pyridoxine HCL. The phosphate ester derivative pyridoxal phosphate generally serves as a coenzyme for many reactions and can help facilitate decarboxylation, transamination, racemization, elimination, replacement and beta-group interconversion reactions. An overdose of pyridoxine can cause a temporary deadening of certain nerves such as the proprioceptory nerves; causing a feeling of disembodiment common with the loss of propioception. This condition is reversible when supplementation is stopped. Accordingly, in a preferred embodiment, the effective amount of vitamin B6 is from about 1 to about 3 mg per day; most preferably about 2 mg per day.

Biotin is necessary for the metabolism of carbohydrates, proteins, and fats and is needed for healthy skin and hair. In a preferred embodiment of the invention, the effective amount of biotin is about 50 to about 70 mcg per day, even more preferably, the effective amount of biotin is about 62.5 mcg per day.

Pantothenic acid, also called vitamin B5, is a water-soluble vitamin required to sustain life. Pantothenic acid is needed to form coenzyme-A (CoA), and is critical in the metabolism and synthesis of carbohydrates, proteins, and fats. The derivative of pantothenic acid, pantothenol, is a more stable form of the vitamin and is often used as a source of the vitamin in multivitamin supplements. Another common supplemental form of the vitamin is calcium pantothenate. Calcium pantothenate is often used in dietary supplements because as a salt, it is more stable than pantothenic acid in the digestive tract allowing for better absorption. Megadoses of pantothenic acid between 500-1200 mg/day has been shown to reduce total serum cholesteron, LDL-cholesterol, and triglycerides, and it may increase HDL-cholesterol. Doses of 2 g/day of calcium pantothenate may reduce the duration of morning stiffness, degree of disability, and pain severity in rheumatoid arthritis patients. The preferred form of pantothenic acid is calcium pantothenate. In one embodiment, the effective amount of pantothenic acid is about 5 to about 10 mg per day; most preferably about 7.5 mg per day.

Megadose vitamin therapy to date has been the approach used to prevent and/or treat certain illnesses or disease states. Traditionally, megadose vitamin therapy is associated with amounts of micronutrients much greater than the RDA for such ingredients. As used herein, a megadose shall mean a dose of a micronutrient that is greater than 200% of the RDA for that micronutrient. Accordingly, it was the intent of the inventors to create nutritional supplements for use in certain indications (improving energy, reducing environmental stress and thereby enhancing immunity) without employing megadose therapy. The nutritional supplements of the present invention are thus believed to avoid potential vitamin toxicity and other harmful side effects often associated with such megadose approaches.

Another factor the inventors had to consider when formulating such nutritional supplements that contain a variety of micronutrients at amounts greater than or equal to the RDA is the ability to incorporate a sufficient amount of vitamins and/or minerals to adequately supplement the dietary intake of those ingredients without making a composition that is too large to ingest, compress into tablets or caplets, or that would require multiple doses.

When formulating such nutritional supplements that contain micronutrients at amounts that are greater than or equal to the RDA, it can be impossible to combine these ingredients with other micronutrients, even at levels equal to or less than the RDA, because of these size and/or processing constraints. The nutritional supplements of the present invention, despite having amounts of ingredients greater or equal to the RDA, can easily be formulated as tablets, capsules and other dosage forms that can easily be swallowed without needing to be administered in multiple doses.

In one embodiment is provided a nutritional supplement and methods for improving energy in a human subject having (a) about 125% to about 130% of the RDA of vitamin B1; (b) about 120 to about 130% of the RDA of vitamin B2; (c) about 120 to about 130% of the RDA of niacin; (d) about 130 to about 150% of the RDA of vitamin B6; (e) about 120 to about 130% of the RDA of biotin; (f) about 120 to about 130% of the RDA of pantothenic acid may be used to improve the energy of the human subject. Most preferably, the nutritional supplements comprises about 127% of the RDA of vitamin B1; (b) about 125% of the RDA of vitamin B2; (c) about 125% of the RDA of niacin; (d) about 143% of the RDA of vitamin B6; (e) about 125% of the RDA of biotin; (f) about 125% of the RDA of pantothenic acid.

The RDA is the standard set of what is considered to be the proper amount of micronutrients required to be consumed by humans as part of their daily diet to ensure adequate dietary intake of such micronutrients. Every several years the RDA is reviewed, modified and updated to reflect changes in science and nutritional beliefs. As used herein, all references to RDA values cited to based upon Directives Commission Directive 2008/100/EC, which has amended Council Directive 90/496/EEC.

The majority of people do not meet the RDA of essential micronutrients through food consumption. Thus, vitamin and mineral supplementation has become a recognized method of meeting accepted medical and health standards. In an alternative embodiment of the invention additional micronutrients may be incorporated into the energy formulations described herein. For example, additional micronutrients include but not limited to vitamin A, vitamin B12, vitamin D, vitamin E, vitamin C, carotenoids, including beta-carotene & lutein, calcium, vitamin K, folic acid, phosphorus, chloride, chromium, iodine, iron, magnesium, manganese, molybdenum, potassium, selenium, copper and zinc, are all examples of micronutrients that may optionally be added to the energy improving and/or enhancing compositions of the present invention.

In a further embodiment of the present invention include methods to improve the energy of the human subject in need thereof. In one embodiment is provided a method for improving energy in a human subject in need thereof having (a) administering a nutritional supplement having (1) an effective amount of vitamin B1, an effective amount of vitamin B2, an effective amount of niacin, an effective amount of vitamin B6, an effective amount of biotin, and an effective amount of pantothenic acid; and (2) wherein the weight ratio of biotin to vitamin B1 is between 1:20 to 1:25; wherein the weight ratio of biotin to vitamin B2 is between 1:25 to about 1:30; wherein the weight ratio of biotin to niacin is between 1:310 to 1:330; wherein the weight ratio of biotin to vitamin B6 is between 1:30 to about 1:35; wherein the weight ratio of biotin to pantothenic acid is between 1:110 to 1:130; and (b) wherein the human subject has improved energy. In a further embodiment, the weight ratio of biotin to vitamin B1 is about 1:22; the weight ratio of biotin to vitamin B2 is about 1:28; the weight ratio of biotin to niacin is about 1:320; the weight ratio of biotin to vitamin B6 is about 1:32; and the weight ratio of biotin to pantothenic acid is about 1:120.

Another aspect of the invention is a nutritional supplement and method for reducing the effects of environmental stress and thus improving immunity in a human subject in need thereof having (1) an effective amount of vitamin E, vitamin C and selenium; and (2) wherein the weight ratio of selenium to vitamin E is about 1:450 to about 1:550; and the weight ratio of selenium to vitamin C is about 1:3000 to about 1:3500. Furthermore, the selenium is present in an amount from about 20 to about 40 mcg; more preferably about 30 mcg.

The inventors further believe that certain combinations of key micronutrients in specific ratios and/or amounts can improve immunity by increasing the level of antioxidants that are important to regulate and strengthen the immune system and maintain the defense system of the human body. Key components of the immune system include the skin and mucous membranes, cilia, lysozyme, complement proteins, phagocytes, natural killer cells, t-cells and cytokines, as well as various antibodies, more specifically the five Ig isotypes. There are a multitude of factors that can affect these immune systems including but not limited to genetics, medications, surgery, diet and nutritional status, physical exercise, environmental and body temperature, environmental stress, and pollution. As used herein, the effects of environmental stress shall include but is not be limited to cell damage caused by free radicals; cell and tissue damage caused by oxidative stress; and other irritants, such as smoke, sun and pollutants. The environmental stress and immunity nutritional supplement of the present invention is believed to reduce the effects of environmental stress by supporting natural cell repair processes and provide protection from stresses on the body caused by pollution and sunlight. By reducing the effects of environmental stress, the inventors believe, without wishing to be bound to any theory, the immunity of a human subject may be synergistically improved. As used herein, “enhanced immunity” and/or “improved immunity” shall include but not be limited to fewer bacterial and/or viral infections either annually or monthly; shortened or decreased time to recover from and/or reduced severity and/or fewer side effects associated with or resulting from such bacterial and/or viral infections; and an overall enhanced and/or improved quality of life. Such bacterial and/or viral infections include but are not limited to colds, influenza, respiratory, allergy and other infections caused by either bacterial and/or viral pathogens known to one skilled in the art.

In a preferred embodiment, the environment stress reducing, immunity enhancing nutritional supplement and methods comprise (a) an effective amount vitamin E, vitamin C, and selenium; and (b) wherein the weight ratio of selenium to vitamin E is about 1:500 and the ratio of selenium to vitamin C is about 1:3333. Furthermore, in a preferred embodiment, the selenium is present in an amount of about 30 mcg.

Vitamin E, a fat-soluble vitamin, is an antioxidant vitamin involved in the metabolism of all cells. It protects vitamin A and essential fatty acids from oxidation in the body cells and prevents breakdown of body tissues. Vitamin E is the generic term for a group of related substances that include alpha-tocopherol, beta-tocopherol, gamma-tocopherol, and delta-tocopherol. In addition, each of these four compounds has a “d” form, which is the natural form, and a “d1” form that is the synthetic form. Preferably, in the nutritional supplement of the present invention, vitamin E is in the natural form. In a preferred embodiment, the nutritional supplement is comprised of about 10 to about 20 mg of vitamin E; and most preferably about 15 mg.

Vitamin C, also known as ascorbic acid, is a water-soluble, antioxidant vitamin. It is important in forming collagen, a protein that gives structure to bones, cartilage, muscle, and blood vessels. Vitamin C also aids in the absorption of iron, and helps maintain capillaries, bones, and teeth. As a water-soluble antioxidant, vitamin C is in a unique position to scavenge aqueous peroxyl radicals before these destructive substances have a chance to damage lipids. It works along with vitamin E, a fat-soluble antioxidant, and the enzyme glutathione peroxidase to stop free radical chain reactions.

Vitamin C can enhance the body's resistance to an assortment of diseases, including infectious disorders and many types of cancer. It strengthens and protects the immune system by stimulating the activity of antibodies and immune system cells such as phagocytes and neutrophils. Vitamin C contributes to a variety of other biochemical functions. These include the biosynthesis of the amino acid carnitine and the catecholamines that regulate the nervous system. It also helps the body to absorb iron and to break down histamine. Although vitamin C is found in every cell, it is especially useful in key parts of the body. These include the blood, the skin, the nervous system, the teeth and bones and glands such as the thymus, adrenals and thyroid.

In a preferred embodiment, the nutritional supplement preferably comprises about 90 to about 110 mg, more preferably about 100 mg of vitamin C.

Selenium is an essential trace element that functions as a component of enzymes involved in antioxidant protection and thyroid hormone metabolism. Selenium possesses antioxidant properties, and has been shown to reduce the risk of heart attack and heart disease. Characteristic signs of selenium deficiency have not been described in humans, but very low selenium status is a factor in the etiologies of a juvenile cardiomyopathy (Keshan Disease) and a chondrodystrophy (Kashin-Beck Disease) that occur in selenium-deficient regions of China.

In a preferred embodiment, the nutritional supplement preferably comprises about 20 to about 50 mcg, even more preferably 30 mcg of selenium.

In still yet another embodiment, the nutritional supplement preferably comprises (a) about 120 to about 130 percent of the RDA of vitamin E, more preferably about 125% of the RDA of vitamin E; (b) about 120 to about 130% of the RDA of vitamin C, most preferably about 125% of the RDA of vitamin C; (c) and about 20 to about 40 mcg of selenium, most preferably about 30 mcg of selenium per day.

It is recognized that other micronutrients can be incorporated into the environmental stress reducing and immunity enhancing nutritional supplements described herein. For example, in addition to the vitamin E, vitamin C, and selenium, additional environmental stress reducing and immunity improving and/or enhancing micronutrients may be added such as vitamin D3, iron, zinc, copper, vitamin A, beta carotene, folate, thiamin, riboflavin, vitamin B6, vitamin B12, vitamin D3, biotin, and pantothenic acid. In a preferred embodiment, the environmental stress reducing and immunity enhancing compositions comprise (a) an effective amount of vitamin D3, an effective amount of iron, an effective amount of zinc, an effective amount of copper, an effective amount of vitamin A, an effective amount of beta carotene, an effective amount of folate, an effective amount of thiamine, an effective amount of riboflavin, an effective amount of vitamin B6, an effective amount of vitamin B12, an effective amount of vitamin D3, an effective amount of biotin, and an effective amount of pantothenic acid; and (b) wherein the weight ratio of selenium to vitamin E is about 1:500, the ratio of selenium to vitamin C is about 1:3333; and the nutritional supplement is effective at reducing the effects of environmental stress and subsequently strengthening the immune system.

In yet still a further embodiment of the invention additional micronutrients may be incorporated into the environmental stress reducing, immunity enhancing nutritional supplements described herein. For example, additional micronutrients include but are not limited to, vitamin E, vitamin C, carotenoids, including betacarotene and lutein, calcium, vitamin K, phosphorus, chloride, chromium, iodine, magnesium, manganese, molybdenum, potassium, and selenium.

Still further another aspect of the invention is a method for reducing the effects of environmental stress and improving immunity in a human subject in need thereof having (1) administering to a nutritional supplement for reducing the effects of environmental stress and improving immunity having (a) an effective amount vitamin E, vitamin C, and selenium; and (b) wherein the weight ratio of selenium to vitamin E is about 1:500, the weight ratio of selenium to vitamin C is about 1:3333; and (2) wherein the human subject the effects of environmental stress are reduced and therefore the human subject has improved immunity.

In a further embodiment, the energy improving nutritional supplements described herein may be administered in combination with the nutritional supplements for reducing environmental stress and immunity so in a single composition is provided a nutritional supplement for improving energy, reducing the effects of environmental stress and improving immunity. Without wishing to be bound to any theory, the inventors believe that each of the biochemical pathways for the indications described herein are interrelated and therefore providing a supplement that may reduce the effects of environmental stress would also then synergistically improve the energy of that human subject as well.

Accordingly, in another embodiment of the present invention, is provided nutritional supplements and methods for improving energy, reducing environmental stress and improving immunity comprising an effective amount an effective amount of vitamin B1, an effective amount of vitamin B2, an effective amount of niacin, an effective amount of vitamin B6, an effective amount of biotin, and an effective amount of pantothenic acid; and wherein the weight ratio of biotin to vitamin B1 is between 1:20 to 1:25; wherein the weight ratio of biotin to vitamin B2 is between 1:25 to about 1:30 wherein the weight ratio of biotin to niacin is between 1:110 to 1:130; wherein the weight ratio of biotin to vitamin B6 is between 1:1 to about 1:5; wherein the weight ratio of biotin to pantothenic acid is between 1:30 to 1:50; and further comprises (a) an effective amount vitamin E, vitamin C, and selenium; and (b) wherein the percent weight ratio of selenium to vitamin E is about 1:450 to about 1:550; the ratio of selenium to vitamin C is about 1:3000 to about 1:3500; and (c) wherein the nutritional supplement is adapted for reducing the effects of environmental stress and improving immunity and further the human subject has improved energy.

In a preferred embodiment, the weight ratio of biotin to vitamin B1 is about 1:22.4; the weight ratio of biotin to vitamin B2 is about 1:28; the weight ratio of biotin to niacin is about 1:320; the weight ratio of biotin to vitamin B6 is about 1:32; the weight ratio of biotin to pantothenic acid is about 1:120; the weight ratio of selenium to vitamin E is about 1:500; and the weight ratio of selenium to vitamin C is about 1:3333. Furthermore, selenium is present in an amount from about 20 to about 40 mcg; more preferable about 30 mcg.

The nutritional supplements described herein may be administered in a single unit dosage form. As used herein, single unit dosage form shall mean a dosage form wherein all the micronutrients of the composition are in a single pill, tablet, caplet, capsule, chewable tablet, quick dissolve tablet, effervescent tablet, hard gelatin capsule, soft gelatin capsule, powder, liquid suspension, and food product. It however is recognized that the single unit dosage form may be administered as a single dose, i.e. take 1 pill per day; or in multiple doses. Preferably the dosage form is administered as 1 dose per day.

The nutritional supplements described herein can be made in a variety of forms, such as the following pharmaceutical compositions: a pill, a tablet, a caplet, a capsule, a chewable tablet, a quick dissolve tablet, an effervescent tablet, a hard gelatin capsule, a soft gelatin capsule, a powder, a liquid suspension, and/or a food product. One skilled in the art would recognize there are also other viable ways for delivering the nutritional supplement to a user. In a preferred embodiment, the nutritional supplement is in a solid dosage form; in an even more preferred embodiment, the solid dosage form is a tablet.

Furthermore, these nutritional supplements can be made using conventional equipment and techniques known in the art. When preparing dosage forms the nutritional components and micronutrients are normally blended with conventional excipients such as binders, including gelatin, pregelatinized starch, and the like; lubricants, such as hydrogenated vegetable oil, stearic acid, and the like; diluents, such as lactose, mannose, and sucrose; disintegrants, such as carboxymethyl cellulose and sodium starch glycolate; suspending agents, such as povidone, polyvinyl alcohol and the like; absorbents, such as silicon dioxide; preservatives, such as methylparaben, propylparaben, and sodium benzoate; surfactants, such as sodium lauryl sulfate, polysorbate 80, and the like; and colorants, such as F.D. & C dyes and the like. Tablets may contain carriers such as lactose and corn starch, and/or lubricating agents such as magnesium stearate. Capsules may contain diluents including lactose and dried corn starch. Aqueous suspensions may contain emulsifying and suspending agents combined with the active ingredient. The oral dosage forms may further contain sweetening and/or flavoring and/or coloring agents.

Furthermore, in addition to the inactive ingredients described herein, the compositions preferably comprise additional micronutrients to supplement the daily dietary intake of those micronutrients.

While the invention has been described with respect to certain specific embodiments, it will be appreciated that many modifications and changes may be made by those skilled in the art without departing from the invention. It is intended, therefore, by the appended claims to cover all such modifications and changes as may fall within the true spirit and scope of the invention.

### EXAMPLES

### Example 1

| Nutrient | Unit | Amount | % RDA |
|---|---|---|---|
| Total A | Mcg | 800 | 100% |
| Vitamin A (retinol) | Mcg | 600 | |
| Beta-Carotene | Mg | 1.2 | |
| Thiamine (B1) | Mg | 1.4 | 127% |
| Riboflavin (B2) | Mg | 1.75 | 125% |
| Niacin | Mg | 20 | 125% |
| Vit B6 | Mg | 2 | 143% |
| Vit B12 | Mcg | 2.5 | 100% |
| Vitamin C | Mg | 100 | 125% |
| Vit D3 | Mcg | 5 | 100% |
| Vitamin E | Mg | 15 | 125% |
| Vitamin K1 | Mcg | 30 | 40% |
| Biotin | Mcg | 62.5 | 125% |
| Folic Acid | Mcg | 200 | 100% |
| Pantothenic Acid | Mg | 7.5 | 125% |
| Calcium | Mg | 162 | 20% |
| Phosphorus | Mg | 125 | 18% |
| Chloride | Mg | 36.3 | 5% |
| Chromium | Mcg | 40 | 100% |
| Copper Sulfate | Mg | 0.5 | 50% |
| Iodine | Mcg | 100 | 67% |
| Iron | Mg | 5 | 36% |
| Magnesium | Mg | 100 | 27% |
| Manganese | Mg | 2 | 100% |
| Molybdenum | Mcg | 50 | 100% |
| Potassium | Mg | 40 | 2% |
| Selenium | Mcg | 30 | 55% |
| Zinc | Mg | 5 | 50% |
| Lutein | Mcg | 500 | |

1. A nutritional supplement comprising (1) vitamin B1, vitamin B2, niacin, vitamin B6, biotin, and pantothenic acid; and (2) wherein the weight ratio of biotin to vitamin B1 is between 1:20 to 1:25; wherein the weight ratio of biotin to vitamin B2 is between 1:25 to 1:30; wherein the weight ratio of biotin to niacin is between 1:310 to 1:330; wherein the weight ratio of biotin to vitamin B6 is between 1:30 to 1:35; wherein the weight ratio of biotin to pantothenic acid is between 1:110 to 1:130.

2. The nutritional supplement of claim 1, wherein the percent weight ratio of biotin to vitamin B1 is about 1:22; the percent weight ratio of biotin to vitamin B2 is about 1:28; the percent weight ratio of biotin to niacin is about 1:320; the percent weight ratio of biotin to vitamin B6 is about 1:32: the percent weight ratio of biotin to pantothenic acid is about 1:120.

3-6. (canceled)

7. The nutritional supplement of claim 1, wherein the amount of vitamin B1 is from about 1 to about 2 mg; the amount of vitamin B2 is from about 1 to about 2 mg; the amount of niacin is about 15 to about 30 mg; the amount of B6 is about 1 to about 3 ma; the amount of biotin is about 50 to about 70 mcg; and the amount of pantothenic acid is about 5 to about 10 mg.

8. The nutritional supplement of claim 7, wherein the amount of vitamin B1 is about 1.4 mg; the amount of vitamin B2 is about 1.75 ma: the amount of niacin is about 20 mg; the amount of vitamin B6 is about 2 mg; the amount of biotin is about 62.5 mcg; and the amount of pantothenic acid is about 7.5 mg.

9-18. (canceled)

19. The nutritional supplement of claim 1, wherein the nutritional supplement further comprises vitamin A, betacarotene, vitamin B12, vitamin C, niacin, vitamin D3, vitamin E, vitamin K1, folic acid, calcium, phosphorus, chloride, chromium, copper sulfate, iodine, iron, magnesium, manganese, molybdenum, potassium, selenium, zinc and lutein.

20-21. (canceled)

22. A nutritional supplement comprising (a) vitamin E, vitamin C, and selenium; (b) wherein the percent weight ratio of selenium to vitamin E is about 1:450 to about 1:550, the ratio of selenium to vitamin C is about 1:3000 to about 1:3500.

23. The nutritional supplement of claim 22, wherein the amount of vitamin E is about 10 to about 20 mg; the amount of vitamin C is about 90 to about 110 mg; the amount of selenium is about 20 to about 50 mcg.

24. The nutritional supplement of claim 23, wherein the amount of vitamin E is about 15 mg; the amount of vitamin C is about 100 mg; the amount of selenium is about 30 mcg.

25-28. (canceled)

29. The nutritional supplement of claim 22, which further comprises vitamin A, beta carotene, vitamin B1, vitamin B2, niacin, vitamin B₆, vitamin B₁₂, vitamin D3, vitamin K1, biotin, folic acid, pantothenic acid, calcium, phosphorus, chloride, chromium, copper sulfate, iodine, iron, magnesium, manganese, molybdenum, potassium, zinc and lutein.

30-38. (canceled)

39. A nutritional supplement comprising (a) vitamin E, vitamin C, and selenium; (b) wherein the percent weight ratio of selenium to vitamin E is about 1:500, the percent weight ratio of selenium to vitamin C is about 1:3000.

40. The nutritional supplement of claim 22, which further comprises vitamin A, beta carotene, vitamin B1, vitamin B2, niacin, vitamin B₆, vitamin B₁₂, vitamin D3, vitamin K1, biotin, folic acid, pantothenic acid, calcium, phosphorus, chloride, chromium, copper sulfate, iodine, iron, magnesium, manganese, molybdenum, potassium, zinc and lutein.

41. A nutritional supplement comprising (a) vitamin E, vitamin C, and selenium; and (b) wherein the ratio of selenium to vitamin E is about 1:500, the ratio of selenium to vitamin C is about 1:3333.

42-43. (canceled)

44. A composition comprising (a) vitamin B1, vitamin B2, niacin, vitamin B6, pantothenic acid, vitamin E, vitamin C and selenium, (b) wherein the weight ratio of biotin to vitamin B1 is between 1:20 to 1:25; wherein the weight ratio of biotin to vitamin B2 is between 1:20 to 1:25; wherein the weight ratio of biotin to niacin is between 1:310 to 1:330; wherein the weight ratio of biotin to vitamin B6 is between 1:30 to 1:35; wherein the weight ratio of biotin to pantothenic acid is between 1:110 to 1:130; wherein the weight ratio of selenium to vitamin E is between 1:450 to 1:550; wherein the weight ratio of selenium to vitamin C is between 1:3000 to 1:3500.
